(19) United States
(12) Patent Application Publication
(10) Pub. No.: US 2008/0012176 A1
(43) Pub. Date: Jan. 17, 2008

(54) Overmolding of molded articles

(75) Inventors: Jeffrey Douglas MacDonald, North York (CA); Alireza Mortazavi, Richmond Hill (CA); Robin Alexander Arnott, Alliston (CA); Robert Domodossola, Brampton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/485,861

(22) Filed: Jul. 13, 2006

(51) Int. Cl. B29C 45/14

(52) U.S. Cl. 264/279; 264/279.1; 425/145; 425/574; 425/575; 425/576

(57) ABSTRACT

Disclosed is overmolding molded articles amongst other things.

### TECHNICAL FIELD

The present invention generally relates to, but is not limited to, systems, and more specifically the present invention relates to, but is not limited to, overmolding molded articles, amongst other things.

### BACKGROUND

Examples of known molding systems are: (i) the HyPET™ Molding System, (ii) the Quadloc™ Molding System, (iii) the Hylectric™ Molding System, and (iv) the HyMet™ Molding System, all manufactured by Husky Injection Molding Systems Limited (Location: Bolton, Ontario, Canada; www.husky.ca).

U.S. Pat. No. 4,243,362 (Inventor: Rees et al; Published: Jan. 1, 1981) discloses an injection-molding machine for molding a composite article from lead and polymer (reference is made to FIG. 4 and column 4 lines 56 to 59 and to column 5 lines 17 to 23).

EP Patent 826,476 (Inventor: Buchholz; Published: Mar. 4, 1998) appears to disclose loading and forming an insert (that is, a tube) in a single mold of a molding system, and then encapsulating or overmolding the insert with a molding material (such as a plastic resin). This approach includes performing the forming operation and the overmolding operation in the single mold.

WO Patent 2004/011315 (Inventor: Staargaard et al; Published: Feb. 5, 2004), WO Patent 2004/056610 (Inventor: Staargaard; Published: Jul. 8, 2004), and United States Patent Application 2003/0077409 (Inventor: Schnell; Published: Apr. 24, 2003) all appear to disclose a process and system for inserting a hydro-formed metal insert into a mold of a molding machine, and then partially encapsulating or overmolding the formed insert with a molding material (such as a plastic resin). This approach includes using different types of machines, one type for forming and another type for molding.

An article titled Secondary Operations: Unique System Uses Press Motion As Punch and Die (published by Plastics World in September 1992, page 10) discloses a molding system having a mold. With the mold opened, a press operator loads a metal insert (that is a metal buss bar) into the mold. As a press closes and clamps, a punch and die mechanism pierces a slug in the insert, and then a nylon-based molding material is injected into the mold to overmold the insert. The forming operation and the overmolding operation are performed sequentially in the same mold.

A document (dated October 1989, titled ALPHA—Multi-processing Technology and published by Krauss Maffei of Germany), discloses the ALPHA molding system that appears to be an integration of several types of molding systems (such as, for example, a compression molding system, an injection molding system and/or a gas-pressure molding system). This arrangement appears to combine different molding materials into a molded article using different processes.

### SUMMARY

According to a first aspect of the present invention, there is provided a system, including a mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

According to a second aspect of the present invention, there is provided a system, including a mold half of a set of mold halves configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

According to a third aspect of the present invention, there is provided a system, including an overmolding station configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

According to a fourth aspect of the present invention, there is provided a system, including a mold half of a group of mold halves configured to cooperate with an overmolding station, the overmolding station configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

According to a fifth aspect of the present invention, there is provided a system, including a thixo-molding station configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

According to a sixth aspect of the present invention, there is provided a system, including a mold half of a collection of mold halves (106; 108; 122) configured to cooperate with a thixo-molding station, the thixo-molding station configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

According to a seventh aspect of the present invention, there is provided a method, including configuring a mold-moving assembly to: cooperate with a thixo-molding station to mold a metallic article from a thixo-molding material, move the metallic article from the thixo-molding station to a overmolding station, and cooperate with the overmolding station to overmold, at least in part, the metallic article with a molding material.

According to an eighth seventh aspect of the present invention, there is provided an article of manufacture usable by a data processing system to control a system operatively coupled to the data processing system, the article of manufacture including a data processing system usable medium embodying one or more instructions executable by the data processing system, the one or more instructions including: instructions for directing a mold-moving assembly to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

A technical effect of the aspects of the present invention, of amongst others, is improved overmolding of articles.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIGS. 1A to 1G are side elevation views of a system according to a first exemplary embodiment; and

FIG. 2 is a schematic block diagram of an article of manufacture according to a second exemplary embodiment used in for controlling the system of FIGS. 1A to 1G.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

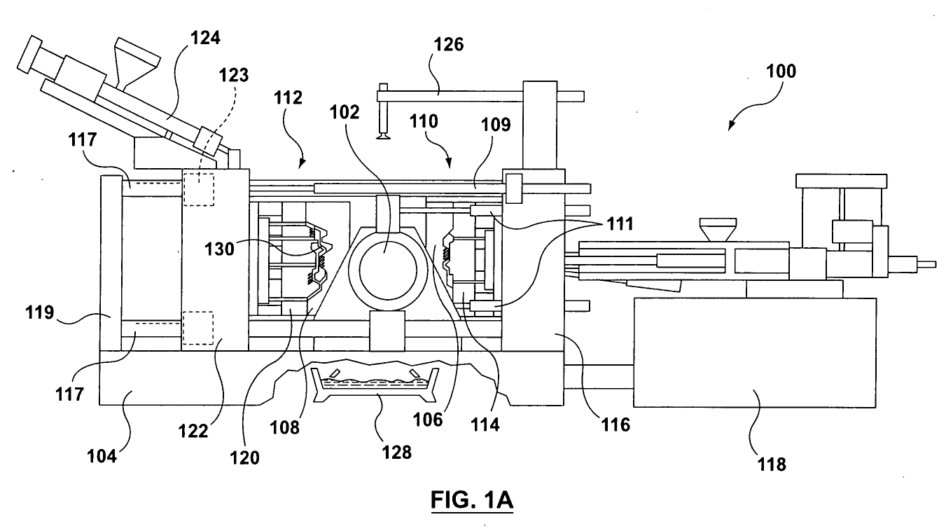

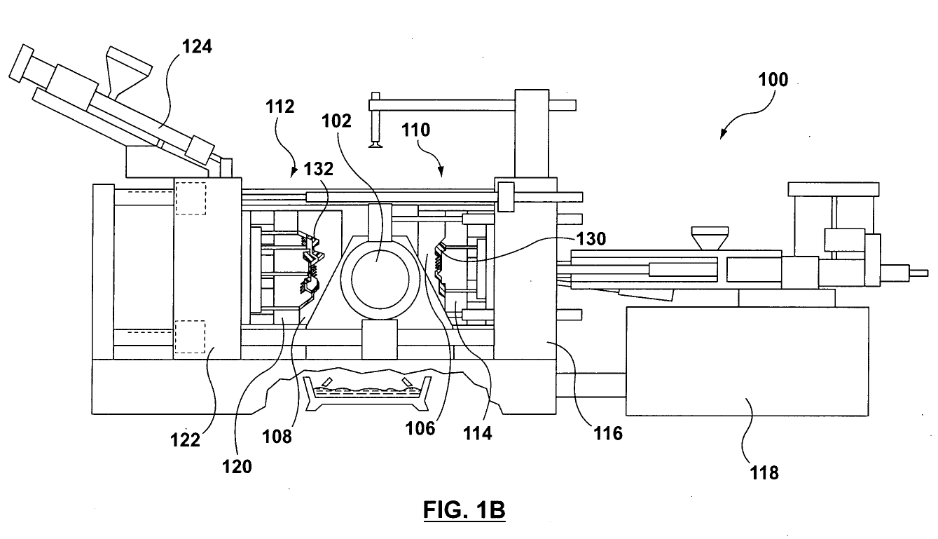

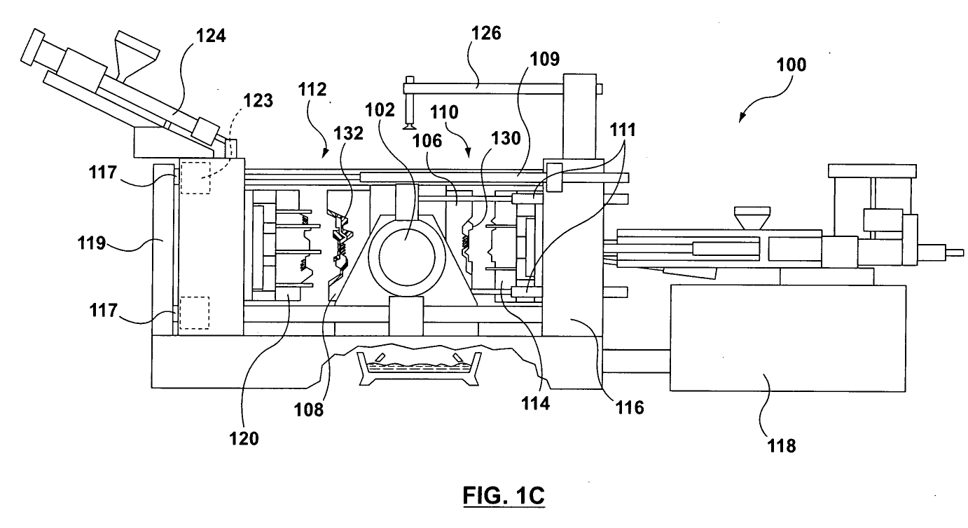

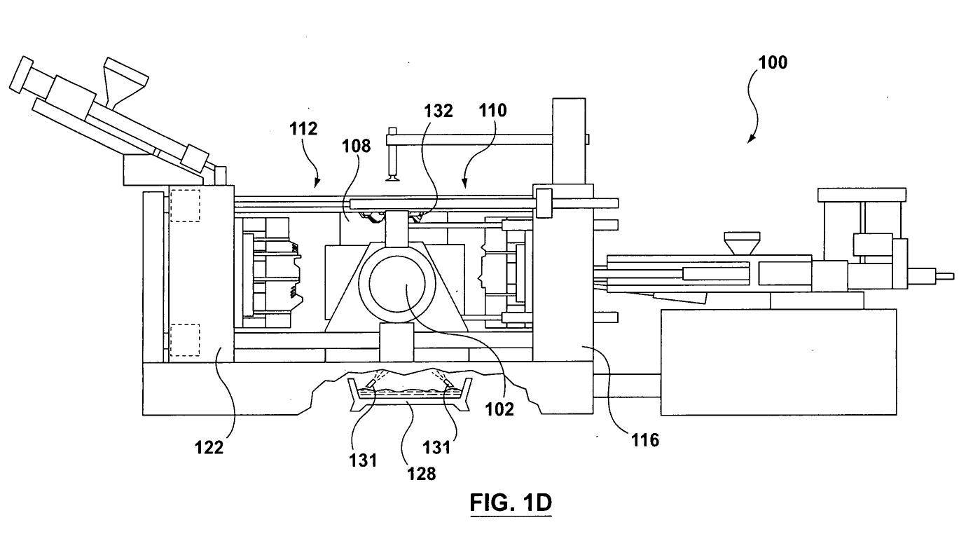

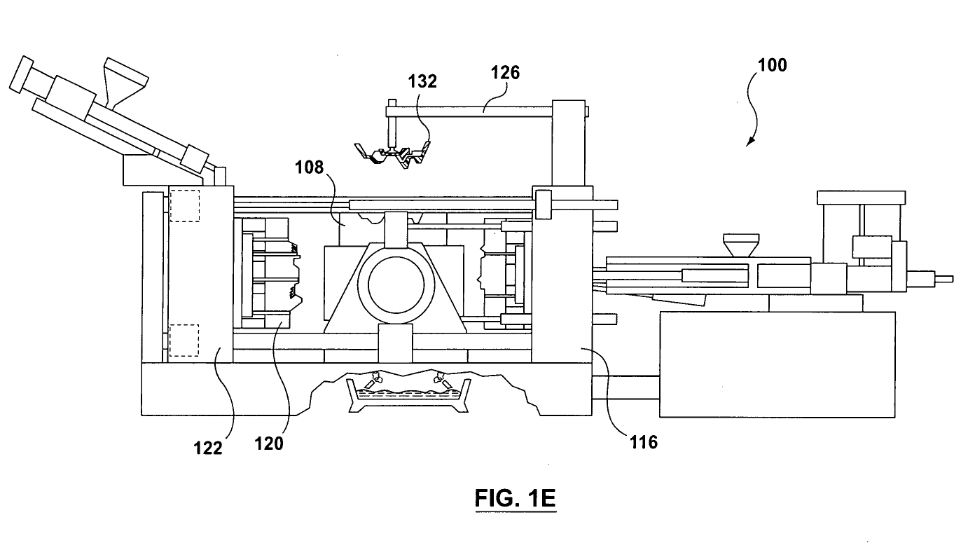

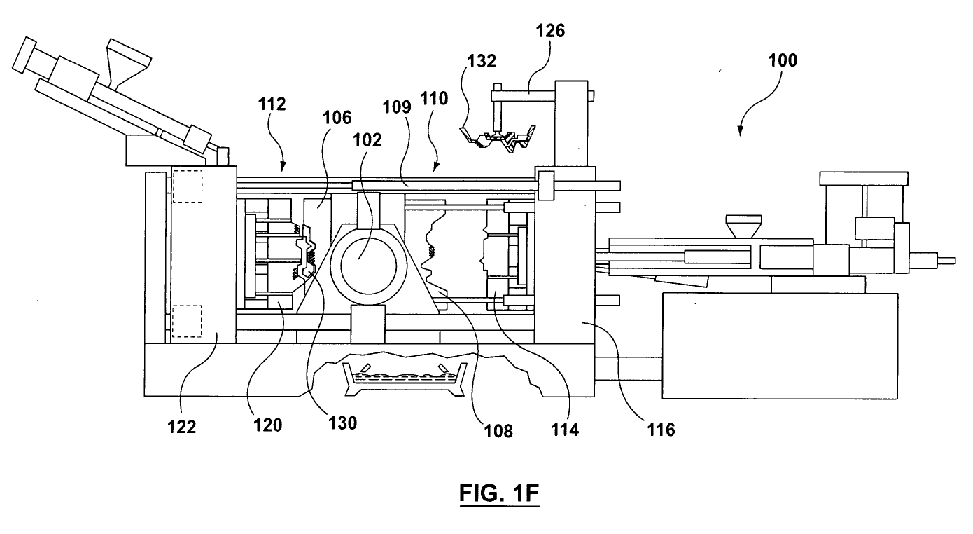

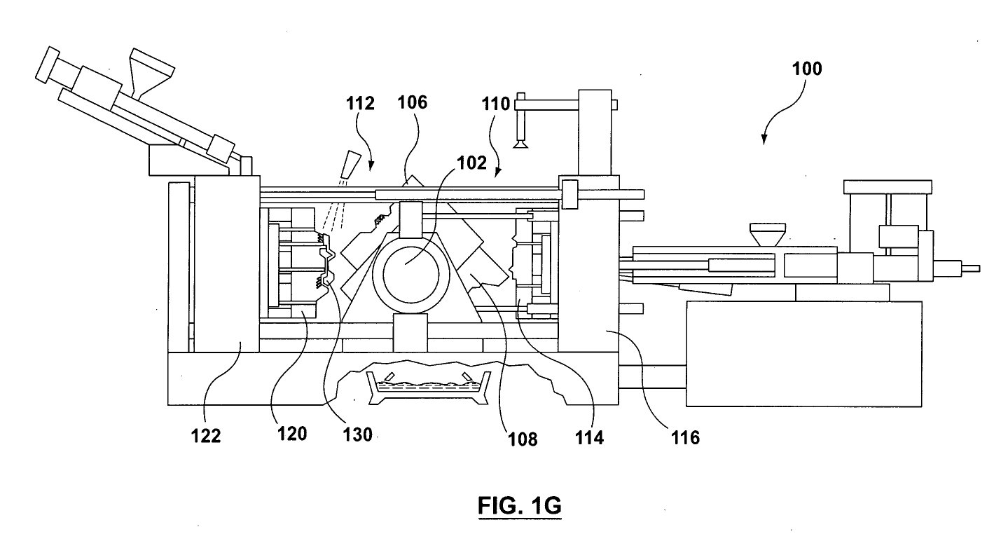

FIGS. 1A to 1G are side elevation views of a system 100 according to the first exemplary embodiment. The elements or components of the system 100 may be supplied by: (i) different vendors, or (ii) a single vendor (that is, a systems integrator).

FIG. 1A depicts a first phase of a cycle of the system 100. The system 100 includes a mold-moving assembly 102 that is configured to: (i) cooperate with a thixo-molding station 110 to mold a metallic article from a thixo-molding material (such as a magnesium alloy, a zinc alloy, an aluminum alloy and/or equivalents thereof), (ii) move the metallic article from the thixo-molding station 110 to an overmolding station (112), and (iii) cooperate with the overmolding station (112) to overmold, at least in part, the metallic article with a molding material (such as a plastic-based molding material and/or a metal-based molding material). The thixo-molding station 110 is hereafter referred to as the “molding station 110”.

According to a variant, the thixo-molding station 110 processes and/or maintains a metal molding material in a thixotropic (slurry) state. According to another variant, the thixo-molding station 110 operates at the near-liquidus range of a metal molding material. The metal olding material may be a magnesium alloy, a zinc alloy, or a metal-matrix composite, which is a combination of a metal alloy and a reinforcement (such as a ceramic powder), etc.

Preferably, the system 100 includes a mold-moving assembly 102. The mold-moving assembly 102 cooperates with: (i) a molding station 110 to mold articles, and (ii) an overmolding station 112 to overmold (at least in part) the molded articles that were molded in the molding station 110. The mold-moving assembly 102 moves the molded articles from the molding station 110 over to the overmolding station 112. A technical effect is, amongst other things, increased cycle time by increasing system integration, and/or a reduction in an accumulation of molded articles between the molding station 110 over to the overmolding station 112.

Preferably, operation of the molding station 110 and operation of the overmolding station 112 overlap one another (at least in part) so that a reduction in cycle time is achieved (another technical effect). Even more preferably, operation of the molding station 110 and operation of the overmolding station 112 overlap each other simultaneously or near simultaneously (that is, overlap of operations occur concurrently) for the best possible reduction in cycle time (another technical effect).

The molding station 110 molds articles made from a molding material, such as: (i) a plastic-based molding material, or (ii) a metal-based molding material. The overmolding station 112 overmolds the molded article with another molding material, such as: (i) a plastic-based molding material, or (ii) a metal-based molding material. The molding material may include a reinforcement material, such as: (i) fibers, (ii) a ceramic powder, or (iii) a colorant, etc.

Preferably, a set of mold halves (106, 108) is attached to the mold-moving assembly 102. The set of mold halves (106, 108) includes: (i) a mold half 106, and (ii) a mold half 108. The mold-moving assembly 102 translates the mold halves 106, 108 along a horizontally-aligned axis (as depicted). According to a variant (not depicted), the mold-moving assembly 102 translates mold halves 106, 108 along a vertically-aligned axis.

Actuators 111 (along with another pair of actuators that are hidden in this view) are used to actuatably translate (slide or stroke) the mold-moving assembly 102 along a base 104 toward and away from the molding station 110 so that the mold halves 106, 114 may be opened or closed relative to each other. A mold half 114 is part of the molding station 110. The mold-moving assembly 102 includes rotation actuators (not depicted) used to move (preferably, rotate) the set of mold halves (106, 108) between the stations 110, 112 so that (i) the mold half 106 is depicted positioned in the molding station 110, and (ii) the mold half 108 is depicted positioned in the overmolding station 112.

The molding station 110 uses a group of mold halves (106; 108; 114) to a mold articles by alternately using the combination of: (i) mold halves (106, 114), or (ii) mold halves (108, 114). A molded article 130 is currently positioned in the station 112, and it was moved over from the station 110 to the station 112. The group of mold halves (106; 108; 114) shares at least one mold half that is common with the set of mold halves (106; 108). The mold half 114 is attached to a stationary platen 116. The actuators 111 are actuated to translate the mold-moving assembly 102 toward and away from the stationary platen 116 so that the mold halves 106, 114 may be: (i) closed against each other, or (ii) separated from each other. Once the mold halves 106, 114 are closed together, a clamping mechanism 123 is actuated to apply a clamping force (via tie bars 117) that clamps up the mold halves 106, 114. Once closed together and clamped up, the mold halves 106, 114 define a mold cavity, into which a primary-injection unit 118 will inject a primary molding material into the mold cavity of the mold halves 106, 114. Once the molded article is solidified in the mold cavity, the clamping mechanism 123 will be actuated to apply a mold-break force that acts to break apart the mold halves 106, 114. Once the mold halves 106, 114 are broken apart, the actuators 111 will be actuated to move the mold-moving assembly 102 away from the mold half 114 so as to so separate the mold halves 106, 114. The mold half 106 retains the molded article so that the mold-moving assembly 102 may then be actuated to rotate the mold halves 106, 108, and the molded article may be rotatably moved over to the overmolding station 112.

The overmolding station 112 uses a collection of mold halves (106; 108; 120) to overmold a secondary molding material into (on to, relative to, etc) the molded article 130 by alternately using the combination of: (i) the mold halves (106, 120) or, (ii) the mold halves (108, 120). The molded article 130 is currently positioned in a mold cavity defined by the mold halves 108, 120 that are closed together and clamped up relative to each other. The collection of mold halves (106; 108; 120) shares at least one “common” mold half with the set of mold halves (106, 108). The mold 120 is attached to a movable platen 122. An actuator 109 (along with another actuator that is hidden in this view) is used to translate (stroke or slide) the movable platen 122 along the base 104 toward and away from the mold-moving assembly 102 so that the mold halves 108, 120 may be opened and closed relative to each other. Once the actuator 109 has closed the mold halves 108, 120 together, the clamping mechanism 123 applies a clamp force to the mold halves 108, 120, and then the secondary molding material will be injected into the mold cavity defined by the mold halves 108, 120 so that the molded article 130 will become overmolded (at least in part).

The tie bars 117 are attached to the stationary platen 116 and extend from the stationary platen 116 through the movable platen 122 and over to a tie-bar support structure 119. Structure 119 is optional. Preferably, the structure 119 is used to prevent the tie bars 117 from sagging (that is, if: (i) the tie bars 117 are not stiff enough or, (ii) the tie bars 117 are too long). Preferably, the clamping mechanism 123 is: (i) contained in the movable platen 122, (ii) actuatable to apply the clamping force or to apply the mold-break force via the tie bars 117 so that these forces may then be transmitted and applied to the mold halves that have been closed. A known structure of the clamping mechanism 123 is a pineapple-type mechanism as known in the molding-system art.

The actuator 109 was actuated to stroke the platen 122 toward the mold-moving assembly 102 so that the mold halves 108, 120 became closed relative to each other; then, the clamping mechanism 123 was actuated to apply the clamping force to the mold halves 108, 120. A secondary-injection unit 124 will be used to inject the secondary molding material into the mold cavity defined by the mold halves 108, 120. The secondary molding material will overmold (at least in part) the molded article 130 positioned in the mold cavity to manufacture an overmolded article 132 (depicted in FIG. 1B). Once the molded article 130 is overmolded (at least in part), the clamping mechanism 123 will be actuated to apply the mold-break force that breaks apart the mold halves 108, 122, and then the actuator 109 will be actuated to move the platen 122 away from the mold-moving assembly 102 so that the mold halves 108, 120 will be separated. Preferably, the mold half 108 retains overmolded article 132 after the mold halves 108, 122 become separated. An article-handling assembly 126 will then be used to remove the overmolded article 132 from the mold half 108.

Preferably the primary-injection unit 118 is a metal-injection unit that injects a metallic alloy (such as: an alloy of magnesium, etc) into the mold cavity to mold a metallic article; and the secondary-injection unit 124 is a plastic-injection unit that injects a plastic-based resin that overmolds the molded metallic article. If the molded article includes a metallic component, a conditioning station 128 includes a cooling bath that is used to spray a coolant (such as water) at the molded metallic article (so as to cool down the metallic article before it becomes overmolded. According to a variant, the conditioning station 128 includes other types of mechanisms for conditioning the molded article, such as cutting, removing, trimming, painting, coating and/or heating of portions of the molded article.

FIG. 1B depicts a second phase of the cycle of the system 100. The primary molding material is injected by the primary-injection unit 118 into the mold cavity defined by the mold halves 106, 114 so as to mold the molded article 130 in the molding station 110. The secondary molding material is injected by the secondary-injection unit 124 into a mold cavity defined by the mold halves 108, 120 so as to overmold the molded article 130 and manufacture an overmolded article 132 in the overmolding station 112.

FIG. 1C depicts a third phase of the cycle of the system 100. The clamping mechanism 123 was actuated to apply the mold-break force (via the tie bars 117) to break apart: (i) the mold halves 108, 120, and (ii) the mold halves 106, 114. The actuator 109 is actuated to: (i) stroke the movable platen 122 away from the mold-moving assembly 102, and (ii) move the mold halves 108, 120 apart. The actuators 111 are actuated to: (i) stroke the mold-moving assembly 102 away form the stationary platen 116, and (ii) move the mold halves 106, 114 apart.

FIG. 1D depicts a fourth phase of the cycle of the system 100, according to a preferred arrangement in which the cooling bath 128 is used. If cooling of the molded article 130 is not required, the fourth phase may be excluded. The mold half 106 retains (by using vacuum lines or magnets, etc) the molded article 130. The mold-moving assembly 102 is actuated to rotate: (i) the mold half 108, and (ii) the mold half 106 ninety degrees so that: (i) the mold half 108 faces directly upwards, and (ii) the mold half 106 faces directly downwardly at the cooling bath 128. The mold half 106 and the article 130 are not depicted in this view because they are hidden. Since the article 130 includes a metallic component that may be too hot to have a molding material overmolded thereto, nozzles 131 of the cooling bath 128 are actuated to spray or apply a coolant (preferably water) from the cooling bath 128 toward the molded article 130 to cool the article 130. According to an alternative (not depicted), the mold half 106 includes a cooling circuit that is used to cool down the article 130 retained by the mold half 106, and in a similar approach, the mold half 108 also includes a cooling circuit.

FIG. 1E depicts a fifth phase of the cycle of the system 100. The article-handling assembly 126 has grabbed and removed the overmolded article 132 from the mold half 108. The article 132 may be taken from the mold half 108 any time after the mold halves 108, 120 become separated from each other (for example, as depicted in FIG. 1C). In addition, the nozzles 131 may continue spraying a coolant (water for example) to further cool down the molded article retained by the mold half 106 that is hidden in this view).

FIG. 1F depicts a sixth phase of the cycle of the system 100. The mold-moving assembly 102 was actuated to rotate the mold half 106 and the mold half 108 ninety degrees so that: (i) the mold half 106 faces the mold half 120 in the overmolding station 112, and (ii) the mold half 108 faces the mold half 114 in the molding station 110. The actuator 109 is actuated to stroke the platen 122 toward the mold-moving assembly 102 so that the mold half 122 is positioned proximate to the article 130. The mold half 122 includes mechanisms that are actuated to grip or retain the article 130. The gripping mechanisms of the mold half 122 are actuated to grip the molded article 130 and the gripping mechanisms of the mold half 106 are then actuated to release the article 130. Preferably, if the article 130 includes magnetizable metal, the mold halves 106, 120 may include magnets that selectively energize to releasably retain the molded article 130.

FIG. 1G depicts a seventh phase of the cycle of the system 100. The mold half 120 retains the molded article 130. The mold-moving assembly 102 is actuated to rotate the mold half 106 and the mold half 108 one hundred and eighty degrees so that: (i) the mold half 106 faces the molding station 110, and (ii) the mold half 108 faces the overmolding station 112. The cycle may be repeated at this point. An optional air-cooling nozzle may be used to further cool down the molded article 130 prior to the mold halves closing against the article 130 in station 112.

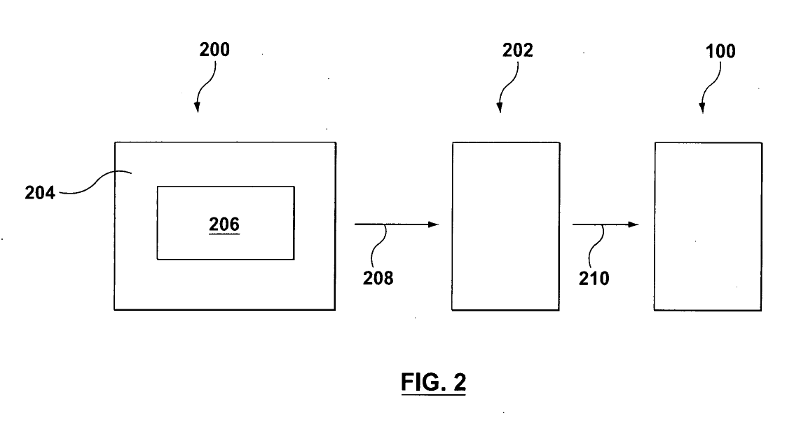

FIG. 2 is a schematic block diagram of an article of manufacture 200 used in for controlling the system 100 of FIGS. 1A to 1G. The article of manufacture 200 is usable by a data processing system 202 to control a system 100 that is operatively coupled to the data processing system 202 by way of wiring 210. The article of manufacture 200 includes a data processing system usable medium 204 embodying one or more instructions 206 executable by the data processing system 202. The article of manufacture 200 may be a floppy disk or an optical disc that is inserted into a media-reading device 208 of the system 202. Alternatively, the article of manufacture 200 may be a hard drive or RAM memory of the data processing system 202. The article of manufacture 200 may be a signal transmitted over a network such as the Internet, in which the signal carries the instructions to the system 202 that is operatively connected to the network.

The one or more instructions 206 include instructions for directing instructions for directing a mold-moving assembly 102 to cooperate with a molding station 110 to mold an article, cooperate with an overmolding station 112 to overmold, at least in part, another article that was molded by the molding station 110 in cooperation with the mold-moving assembly 102, and move molded articles between the molding station 110 and the overmolding station, and also include instructions for directing operation of the molding station 110 and operation of the overmolding station 112 to overlap one another at least in part to reduce cycle time.

Preferably, the instructions 206 include the following instructions (in no particular order):

(i) instructions for directing the mold-moving assembly 102 to move a set of mold halves 106, 108 between the molding station 110 and the overmolding station 112, and instructions for directing the set of mold halves 106, 108 to cooperate with the molding station 110 to form the molded article 130 at least in part;

(ii) instructions for directing the mold-moving assembly 102 to move a set of mold halves 106, 108 between the molding station 110 and the overmolding station 112, and instructions for directing the molding station 110 to include a group of mold halves 106, 108, 114 configured to cooperate with the set of mold halves 106, 108 to form the molded article 130 at least in part;

(iii) instructions for directing the mold-moving assembly 102 to move a set of mold halves 106, 108 between the molding station 110 and the overmolding station 112, and instructions for directing the set of mold halves 106, 108 to cooperate with the overmolding station 112 to encapsulate a molding material relative to the molded article 130 at least in part;

(iv) instructions for directing the mold-moving assembly 102 to move a set of mold halves 106, 108 between the molding station 110 and the overmolding station 112, and instructions for directing the overmolding station 112 includes a collection of mold halves 106, 108, 120 configured to cooperate with the set of mold halves 106, 108 to overmold a molding material relative to the molded article 130 at least in part;

(v) instructions for directing the mold-moving assembly 102 to rotate a set of mold halves 106, 108 between the molding station 110 and the overmolding station 112;

(vi) instructions for directing the mold-moving assembly 102 to linearly translate a set of mold halves 106, 108 between the molding station 110 and the overmolding station 112;

(vii) instructions for directing the mold-moving assembly 102 to move a set of mold halves 106, 108 between the molding station 110 and the overmolding station 112, and instructions for directing a retaining structure of the set of mold halves 106, 108 to releasably retain the molded article 130; and

(viii) instructions for directing the molding station 110 to mold the molded article 130, and instructions for directing the overmolding station 112 to overmold the molded article 130).

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A system, comprising:
a mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

2. The system of claim 1, wherein operation of the thixo-molding station and operation of the overmolding station overlap one another at least in part to reduce cycle time.

3. The system of claim 1, wherein the thixo-molding station is configured to form the molded article at least in part, and wherein the overmolding station is configured to encapsulate a molding material onto the molded article at least in part.

4. The system of claim 1, wherein the mold-moving assembly is configured to move a set of mold halves between the thixo-molding station and the overmolding station, and wherein the set of mold halves is configured to cooperate with the thixo-molding station to form the molded article at least in part.

5. The system of claim 1, wherein the mold-moving assembly is configured to move a set of mold halves between the thixo-molding station and the overmolding station, and wherein the thixo-molding station includes a group of mold halves configured to cooperate with the set of mold halves to form the molded article at least in part.

6. The system of claim 1, wherein the mold-moving assembly is configured to move a set of mold halves between the thixo-molding station and the overmolding station, and wherein the set of mold halves is configured to cooperate with the overmolding station to encapsulate a molding material relative to the molded article at least in part.

7. The system of claim 1, wherein the mold-moving assembly is configured to move a set of mold halves between the thixo-molding station and the overmolding station, and wherein the overmolding station includes a collection of mold halves configured to cooperate with the set of mold halves to overmold a molding material relative to the molded article at least in part.

8. The system of claim 1, wherein the mold-moving assembly is configured to rotate a set of mold halves between the thixo-molding station and the overmolding station.

9. The system of claim 1, wherein the mold-moving assembly is configured to linearly translate a set of mold halves between the thixo-molding station and the overmolding station.

10. The system of claim 1, wherein the mold-moving assembly is configured to move a set of mold halves between the thixo-molding station and the overmolding station, and wherein the set of mold halves includes a retaining structure configured to releasably retain the molded article.

11. The system of claim 1, wherein the thixo-molding station is configured to mold the molded article, and the overmolding station is configured to overmold the molded article.

12. A system, comprising:
a mold half of a set of mold halves configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

13. The system of claim 12, wherein operation of the thixo-molding station and operation of the overmolding station overlap one another at least in part to reduce cycle time.

14. The system of claim 12, wherein the thixo-molding station is configured to form the molded article at least in part, and wherein the overmolding station is configured to encapsulate a molding material onto the molded article at least in part.

15. The system of claim 12, wherein the mold-moving assembly is configured to move a set of mold halves between the thixo-molding station and the overmolding station, and wherein the set of mold halves is configured to cooperate with the thixo-molding station to form the molded article at least in part.

16. The system of claim 12, wherein the mold-moving assembly is configured to move a set of mold halves between the thixo-molding station and the overmolding station, and wherein the thixo-molding station includes a group of mold halves configured to cooperate with the set of mold halves to form the molded article at least in part.

17. The system of claim 12, wherein the mold-moving assembly is configured to move a set of mold halves between the thixo-molding station and the overmolding station, and wherein the set of mold halves is configured to cooperate with the overmolding station to encapsulate a molding material relative to the molded article at least in part.

18. The system of claim 12, wherein the mold-moving assembly is configured to move a set of mold halves between the thixo-molding station and the overmolding station, and wherein the overmolding station includes a collection of mold halves configured to cooperate with the set of mold halves to overmold a molding material relative to the molded article at least in part.

19. The system of claim 12, wherein the mold-moving assembly is configured to rotate a set of mold halves between the thixo-molding station and the overmolding station.

20. The system of claim 12, wherein the mold-moving assembly is configured to linearly translate a set of mold halves between the thixo-molding station and the overmolding station.

21. The system of claim 12, wherein the mold-moving assembly is configured to move a set of mold halves between the thixo-molding station and the overmolding station, and wherein the set of mold halves includes a retaining structure configured to releasably retain the molded article.

22. The system of claim 12, wherein the thixo-molding station is configured to mold the molded article, and the overmolding station is configured to overmold the molded article.

23. A system, comprising:
an overmolding station configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

24. The system of claim 23, wherein operation of the thixo-molding station and operation of the overmolding station overlap one another at least in part to reduce cycle time.

25. The system of claim 23, wherein the thixo-molding station is configured to form the molded article at least in part, and wherein the overmolding station is configured to encapsulate a molding material onto the molded article at least in part.

26. The system of claim 23, wherein the mold-moving assembly is configured to move a set of mold halves between the thixo-molding station and the overmolding station, and wherein the set of mold halves is configured to cooperate with the thixo-molding station to form the molded article at least in part.

27. The system of claim 23, wherein the mold-moving assembly is configured to move a set of mold halves between the thixo-molding station and the overmolding station, and wherein the thixo-molding station includes a group of mold halves configured to cooperate with the set of mold halves to form the molded article at least in part.

28. The system of claim 23, wherein the mold-moving assembly is configured to move a set of mold halves between the thixo-molding station and the overmolding station, and wherein the set of mold halves is configured to cooperate with the overmolding station to encapsulate a molding material relative to the molded article at least in part.

29. The system of claim 23, wherein the mold-moving assembly is configured to move a set of mold halves between the thixo-molding station and the overmolding station, and wherein the overmolding station includes a collection of mold halves configured to cooperate with the set of mold halves to overmold a molding material relative to the molded article at least in part.

30. The system of claim 23, wherein the mold-moving assembly is configured to rotate a set of mold halves between the thixo-molding station and the overmolding station.

31. The system of claim 23, wherein the mold-moving assembly is configured to linearly translate a set of mold halves between the thixo-molding station and the overmolding station.

32. The system of claim 23, wherein the mold-moving assembly is configured to move a set of mold halves between the thixo-molding station and the overmolding station, and wherein the set of mold halves includes a retaining structure configured to releasably retain the molded article.

33. The system of claim 23, wherein the thixo-molding station is configured to mold the molded article, and the overmolding station is configured to overmold the molded article.

34. A system, comprising:
a mold half of a group of mold halves configured to cooperate with an overmolding station, the overmolding station configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

35. The system of claim 34, wherein operation of the thixo-molding station and operation of the overmolding station overlap one another at least in part to reduce cycle time.

36. The system of claim 34, wherein the thixo-molding station is configured to form the molded article at least in part, and wherein the overmolding station is configured to encapsulate a molding material onto the molded article at least in part.

37. The system of claim 34, wherein the mold-moving assembly is configured to move a set of mold halves between the thixo-molding station and the overmolding station, and wherein the set of mold halves is configured to cooperate with the thixo-molding station to form the molded article at least in part.

38. The system of claim 34, wherein the mold-moving assembly is configured to move a set of mold halves between the thixo-molding station and the overmolding station, and wherein the thixo-molding station includes a group of mold halves configured to cooperate with the set of mold halves to form the molded article at least in part.

39. The system of claim 34, wherein the mold-moving assembly is configured to move a set of mold halves between the thixo-molding station and the overmolding station, and wherein the set of mold halves is configured to cooperate with the overmolding station to encapsulate a molding material relative to the molded article at least in part.

40. The system of claim 34, wherein the mold-moving assembly is configured to move a set of mold halves between the thixo-molding station and the overmolding station, and wherein the overmolding station includes a collection of mold halves configured to cooperate with the set of mold halves to overmold a molding material relative to the molded article at least in part.

41. The system of claim 34, wherein the mold-moving assembly is configured to rotate a set of mold halves between the thixo-molding station and the overmolding station.

42. The system of claim 34, wherein the mold-moving assembly is configured to linearly translate a set of mold halves between the thixo-molding station and the overmolding station.

43. The system of claim 34, wherein the mold-moving assembly is configured to move a set of mold halves between the thixo-molding station and the overmolding station, and wherein the set of mold halves includes a retaining structure configured to releasably retain the molded article.

44. The system of claim 34, wherein the thixo-molding station is configured to mold the molded article, and the overmolding station is configured to overmold the molded article.

45. A system, comprising:
a thixo-molding station configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

46. The system of claim 45, wherein operation of the thixo-molding station and operation of the overmolding station overlap one another at least in part to reduce cycle time.

47. The system of claim 45, wherein the thixo-molding station is configured to form the molded article at least in part, and wherein the overmolding station is configured to encapsulate a molding material onto the molded article at least in part.

48. The system of claim 45, wherein the mold-moving assembly is configured to move a set of mold halves between the thixo-molding station and the overmolding station, and wherein the set of mold halves is configured to cooperate with the thixo-molding station to form the molded article at least in part.

49. The system of claim 45, wherein the mold-moving assembly is configured to move a set of mold halves between the thixo-molding station and the overmolding station, and wherein the thixo-molding station includes a group of mold halves configured to cooperate with the set of mold halves to form the molded article at least in part.

50. The system of claim 45, wherein the mold-moving assembly is configured to move a set of mold halves between the thixo-molding station and the overmolding station, and wherein the set of mold halves is configured to cooperate with the overmolding station to encapsulate a molding material relative to the molded article at least in part.

51. The system of claim 45, wherein the mold-moving assembly is configured to move a set of mold halves between the thixo-molding station and the overmolding station, and wherein the overmolding station includes a collection of mold halves configured to cooperate with the set of mold halves to overmold a molding material relative to the molded article at least in part.

52. The system of claim 45, wherein the mold-moving assembly is configured to rotate a set of mold halves between the thixo-molding station and the overmolding station.

53. The system of claim 45, wherein the mold-moving assembly is configured to linearly translate a set of mold halves between the thixo-molding station and the overmolding station.

54. The system of claim 45, wherein the mold-moving assembly is configured to move a set of mold halves between the thixo-molding station and the overmolding station, and wherein the set of mold halves includes a retaining structure configured to releasably retain the molded article.

55. The system of claim 45, wherein the thixo-molding station is configured to mold the molded article, and the overmolding station is configured to overmold the molded article.

56. A system, comprising:
a mold half of a collection of mold halves configured to cooperate with a thixo-molding station, the thixo-molding station configured to cooperate with a mold-moving assembly, the mold-moving assembly configured to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

57. The system of claim 56, wherein operation of the thixo-molding station and operation of the overmolding station overlap one another at least in part to reduce cycle time.

58. The system of claim 56, wherein the thixo-molding station is configured to form the molded article at least in part, and wherein the overmolding station is configured to encapsulate a molding material onto the molded article at least in part.

59. The system of claim 56, wherein the mold-moving assembly is configured to move a set of mold halves between the thixo-molding station and the overmolding station, and wherein the set of mold halves is configured to cooperate with the thixo-molding station to form the molded article at least in part.

60. The system of claim 56, wherein the mold-moving assembly is configured to move a set of mold halves between the thixo-molding station and the overmolding station, and wherein the thixo-molding station includes a group of mold halves configured to cooperate with the set of mold halves to form the molded article at least in part.

61. The system of claim 56, wherein the mold-moving assembly is configured to move a set of mold halves between the thixo-molding station and the overmolding station, and wherein the set of mold halves is configured to cooperate with the overmolding station to encapsulate a molding material relative to the molded article at least in part.

62. The system of claim 56, wherein the mold-moving assembly is configured to move a set of mold halves between the thixo-molding station and the overmolding station, and wherein the overmolding station includes a collection of mold halves configured to cooperate with the set of mold halves to overmold a molding material relative to the molded article at least in part.

63. The system of claim 56, wherein the mold-moving assembly is configured to rotate a set of mold halves between the thixo-molding station and the overmolding station.

64. The system of claim 56, wherein the mold-moving assembly is configured to linearly translate a set of mold halves between the thixo-molding station and the overmolding station.

65. The system of claim 56, wherein the mold-moving assembly is configured to move a set of mold halves between the thixo-molding station and the overmolding station, and wherein the set of mold halves includes a retaining structure configured to releasably retain the molded article.

66. The system of claim 56, wherein the thixo-molding station is configured to mold the molded article, and the overmolding station is configured to overmold the molded article.

67. A method, comprising:
configuring a mold-moving assembly to:
cooperate with a thixo-molding station to mold a metallic article from a thixo-molding material,
move the metallic article from the thixo-molding station to a overmolding station, and
cooperate with the overmolding station to overmold, at least in part, the metallic article with a molding material.

68. The method of claim 67, further comprising:
configuring operation of the thixo-molding station and operation of the overmolding station to overlap one another at least in part to reduce cycle time.

69. The method of claim 67, further comprising:
configuring the thixo-molding station to form the molded article at least in part; and
configuring the overmolding station to encapsulate a molding material onto the molded article at least in part.

70. The method of claim 67, further comprising:
configuring the mold-moving assembly to move a set of mold halves between the thixo-molding station and the overmolding station; and
configuring the set of mold halves to cooperate with the thixo-molding station to form the molded article at least in part.

71. The method of claim 67, further comprising:
configuring the mold-moving assembly to move a set of mold halves between the thixo-molding station and the overmolding station; and
configuring the thixo-molding station to include a group of mold halves configured to cooperate with the set of mold halves to form the molded article at least in part.

72. The method of claim 67, further comprising:
configuring the mold-moving assembly to move a set of mold halves between the thixo-molding station and the overmolding station; and
configuring the set of mold halves to cooperate with the overmolding station to encapsulate a molding material relative to the molded article at least in part.

73. The method of claim 67, further comprising:
configuring the mold-moving assembly to move a set of mold halves between the thixo-molding station and the overmolding station; and
configuring the overmolding station includes a collection of mold halves configured to cooperate with the set of mold halves to overmold a molding material relative to the molded article at least in part.

74. The method of claim 67, further comprising:
configuring the mold-moving assembly to rotate a set of mold halves between the thixo-molding station and the overmolding station.

75. The method of claim 67, further comprising:
configuring the mold-moving assembly to linearly translate a set of mold halves between the thixo-molding station and the overmolding station.

76. The method of claim 67, further comprising:
configuring the mold-moving assembly to move a set of mold halves between the thixo-molding station and the overmolding station; and
configuring the set of mold halves to include a retaining structure configured to releasably retain the molded article.

77. The method of claim 67, further comprising:
configuring the thixo-molding station to mold the molded article; and
configuring the overmolding station to overmold the molded article.

78. An article of manufacture usable by a data processing system to control a system operatively coupled to the data processing system, the article of manufacture comprising:
a data processing system usable medium embodying one or more instructions executable by the data processing system, the one or more instructions including:
instructions for directing a mold-moving assembly to: (i) cooperate with a thixo-molding station to mold a metallic article from a thixo-molding material, (ii) move the metallic article from the thixo-molding station to a overmolding station, and (iii) cooperate with the overmolding station to overmold, at least in part, the metallic article with a molding material.

79. The article of manufacture of claim 78, further comprising:
instructions for directing operation of the thixo-molding station and operation of the overmolding station to overlap one another at least in part to reduce cycle time.

80. The article of manufacture of claim 78, further comprising:
instructions for directing the thixo-molding station to form the molded article at least in part; and
instructions for directing the overmolding station to encapsulate a molding material onto the molded article at least in part.

81. The article of manufacture of claim 78, further comprising:
instructions for directing the mold-moving assembly to move a set of mold halves between the thixo-molding station and the overmolding station; and
instructions for directing the set of mold halves to cooperate with the thixo-molding station to form the molded article at least in part.

82. The article of manufacture of claim 78, further comprising:
instructions for directing the mold-moving assembly to move a set of mold halves between the thixo-molding station and the overmolding station; and
instructions for directing the thixo-molding station to include a group of mold halves configured to cooperate with the set of mold halves to form the molded article at least in part.

83. The article of manufacture of claim 78, further comprising:
instructions for directing the mold-moving assembly to move a set of mold halves between the thixo-molding station and the overmolding station; and
instructions for directing the set of mold halves to cooperate with the overmolding station to encapsulate a molding material relative to the molded article at least in part.

84. The article of manufacture of claim 78, further comprising:
instructions for directing the mold-moving assembly to move a set of mold halves between the thixo-molding station and the overmolding station; and
instructions for directing the overmolding station includes a collection of mold halves configured to cooperate with the set of mold halves to overmold a molding material relative to the molded article at least in part.

85. The article of manufacture of claim 78, further comprising:
instructions for directing the mold-moving assembly to rotate a set of mold halves between the thixo-molding station and the overmolding station.

86. The article of manufacture of claim 78, further comprising:
instructions for directing the mold-moving assembly to linearly translate a set of mold halves between the thixo-molding station and the overmolding station.

87. The article of manufacture of claim 78, further comprising:
instructions for directing the mold-moving assembly to move a set of mold halves between the thixo-molding station and the overmolding station; and
instructions for directing a retaining structure of the set of mold halves to releasably retain the molded article.

88. The article of manufacture of claim 78, further comprising:
instructions for directing the thixo-molding station to mold the molded article; and
instructions for directing the overmolding station to overmold the molded article.

89. A composite article manufactured by the system of claim 1.
